(19) United States
(12) Patent Application Publication
(10) Pub. No.: US 2012/0161047 A1
(43) Pub. Date: Jun. 28, 2012

(54) Solenoid Valve

(75) Inventors: Massimiliano Ambrosi, Marbach (DE); Elmar Vier, Freiberg A. N. (DE); Andreas Karl, Benningen/Neckar (DE); Andreas Lechler, Vaihingen/Enz (DE); Nicolas Houis, Bietigheim-Bissingen (DE); Gerhard Stokmaier, Markgroeningen (DE); Stephan Steingass, Bornheim (DE); Jens Norberg, Stuttgart (DE)

(73) Assignee: Robert Bosch GmbH, Stuttgart (DE)

(21) Appl. No.: 13/329,864

(22) Filed: Dec. 19, 2011

(30) Foreign Application Priority Data
Dec. 21, 2010 (DE) 10 2010 063 727.0

(51) Int. Cl. F16K 31/02

(52) U.S. Cl. 251/129.15

(57) ABSTRACT

A solenoid valve includes a housing which extends in the axial direction and has at least one axial section which is embodied as a circular hollow cylinder, and a solenoid armature which is removably guided in the housing along a cylinder inner wall in an axial direction along the longitudinal axis of said housing and the solenoid armature having a solenoid armature casing wall. At least one axial flow duct for a medium is located in the housing and is provided to permit a flow around the solenoid armature. The flow duct has a first and a second duct wall region, and the first duct wall region is formed by a section of the cylinder inner wall and the second duct wall region is formed by a section of the solenoid armature casing wall. The second duct wall region is embodied as a planar second duct wall region.

This application claims priority under 35 U.S.C. §119 to patent application no. DE 10 2010 063 727.0, filed on Dec. 21, 2010 in Germany, the disclosure of which is incorporated herein by reference in its entirety.

The disclosure relates to a solenoid valve having a housing which extends in the axial direction and has at least one axial section which is embodied as a circular hollow cylinder, and having a solenoid armature which is removably guided in the housing along a cylinder inner wall in an axial direction along the longitudinal axis of said housing and has a solenoid armature having a solenoid armature casing wall, wherein at least one axial flow duct for a medium which is located in the housing is provided to permit a flow around the solenoid armature, and wherein the flow duct has a first and a second duct wall region, and the first duct wall region is formed by a section of the cylinder inner wall and the second duct wall region is formed by a section of the solenoid armature casing wall.

### BACKGROUND

Solenoid valves of the type mentioned at the beginning are known from the prior art. These valves are used, for example, in anti-lock brake systems (ABS), traction control systems (TCS) and/or electric stability programs (ESP) of motor vehicles. The solenoid armature is displaceably guided in the housing in the manner of a piston, wherein there can be a flow of medium around said piston by forming a wedge-groove-shaped flow duct. Owing to the flow duct, the movement of the solenoid armature in the housing is hydraulically damped. The use of solenoid valves with such solenoid armatures can lead to undesired noise effects in the vehicle owing to oscillations and/or the desired damping of the solenoid armature movement is not sufficient under certain circumstances.

### SUMMARY

In a solenoid valve of the type mentioned at the beginning, there is provision according to the disclosure that the second duct wall region is embodied as a planar second duct wall region. On the basis of the inventive embodiment of the two duct wall regions, the flow duct has a circular segment shape in cross section. The piston-shaped solenoid armature is guided in the housing, wherein said solenoid armature can carry out an axial movement along its longitudinal axis by virtue of this arrangement. Piston-shaped means in this context that the solenoid armature moves along the cylinder inner wall with low friction when it is displaced axially. A medium contributes to damping the movement of the solenoid armature, wherein the medium is located in the housing. Said medium flows through the flow duct during the movement of the solenoid armature by virtue of expulsion. As a result of the inventive second duct wall region which is of planar design and which is formed by the section of the solenoid armature casing wall which is embodied as a plane, an advantageous wetting situation of this section of the solenoid armature casing wall is implemented for the flowing medium. Owing to the internal friction of the medium, shearing layers are formed therein. This involves the movement of the solenoid armature being hydraulically damped in the housing, wherein owing to the inventive configuration of the second duct wall region a particularly large and advantageous damping effect is brought about. As a result, undesired noise effects in the vehicle are minimized when the solenoid valve according to the disclosure is used. In order to implement such a flow duct and the corresponding damping effect it is possible to manufacture the solenoid armature according to the disclosure by shaping, in particular cold shaping, preferably cold forming, of a solenoid armature blank. Owing to the simplified geometry of a second duct wall region which is shaped as a plane in contrast to a wedge-groove-shaped second duct wall region, a relatively simple manufacturing process within a predefined dimensional accuracy is possible, and the dimensional accuracy can be checked with simple means.

According to one development of the disclosure there is provision that the solenoid armature has at least a cylinder shape which, when viewed in cross section, has a straight contour region originating from the second duct wall region and a contour region in the form of a pitch circle. Accordingly, the section of the solenoid armature casing wall, which has the pitch-circle-shaped contour region in cross section, bears against the section of the cylinder inner wall which is in the shape of a pitch circle in cross section. The linear contour region corresponds in three dimensions to the section of the solenoid armature casing wall which is embodied as a plane. This plane forms the second duct wall region.

There is preferably provision that the second duct wall region runs parallel to the longitudinal axis of the solenoid armature. The section of the solenoid armature casing wall which is embodied as a plane is therefore parallel to the longitudinal axis of the solenoid armature, and the magnitude of the cross section of the flow duct remains constant along its axial extent. The shearing layers, which are formed in the medium and also bring about the damping of the solenoid armature movement, run in this respect parallel to the longitudinal axis and to the second duct wall region.

According to one development of the disclosure there is provision that the housing is embodied as a stepped housing, with at least two axial sections which have diameters of different sizes and are embodied as circular hollow cylinders. The axial sections are, when viewed in the direction of the longitudinal axis of the solenoid armature, arranged one behind the other and each have a central axis. In particular, the central axes of the axial sections of the stepped housing can be aligned with one another. The circular hollow cylinders can have different heights. Owing to the differently sized diameters of the circular hollow cylinders, these may each accommodate sections of the solenoid armature with different diameters.

It is advantageous if the solenoid armature is embodied as a stepped solenoid armature, with at least two cylinder sections which are located with an axial offset with respect to the longitudinal axis thereof, and wherein at least one of the cylinder sections has the flow duct. At least one of the cylinder sections has, when viewed in cross section, a straight contour region originating from the second duct wall region and a contour region in the form of a pitch circle. The flow duct therefore extends along the at least one cylinder section. If the flow duct extends through more than the one cylinder section, the second duct wall region runs along a plurality of cylinder sections as a planar second duct wall region.

According to a further refinement of the disclosure there is provision that a junction region is arranged between the two cylinder sections. The cylinder sections which are located axially offset with respect to one another do not directly adjoin but instead enclose the junction region between them, said junction region having a specific height when viewed in the axial direction. The junction region has a casing surface which can be shaped in any desired fashion, wherein the flow duct can extend radially into the junction region, depending on the magnitude of the cross-sectional dimension.

There is preferably provision that the junction region is embodied as a truncated cone, in particular as a circular truncated cone. The shaping of the junction region is accordingly selected such that the base surface of the truncated cone corresponds to an end surface of the one cylinder section, and that the end surface of the truncated cone corresponds to a base surface of the other cylinder section. As a result, a continuous transition is implemented between the casing walls of the cylinder sections, and the casing surface of the junction region is as small as possible. The central axis of the truncated cone is aligned with the longitudinal axes of the cylinder sections and corresponds in this respect to the longitudinal axis of the solenoid armature.

In addition, it is advantageous that the flow duct penetrates the junction region. The casing wall of the junction region accordingly has a region which is embodied as a planar surface and which forms at least part of the second duct wall region of the flow duct. This region which is embodied in a planar fashion adjoins that section of the casing wall of the at least one cylinder section which is embodied as a planar surface.

Finally, it is advantageous if the solenoid valve has a plurality of flow ducts which are arranged distributed in the circumferential direction. These flow ducts run parallel to one another. If the solenoid armature is embodied as a stepped solenoid armature, the flow ducts can each extend over one or more cylinder sections and/or the junction regions. Furthermore, the flow ducts may differ in the size of their circular-segment-shaped cross section, and the quantity of the medium which is located at the respective flow duct, and in this respect the formation of the shearing layers in the medium, can therefore be influenced in an individual fashion, as can the wetting situation of the second duct wall region of the respective flow duct. What has been stated above applies correspondingly when there are equally large cross sections of a number of flow ducts, wherein the selection of the number serves as an influencing variable.

### BRIEF DESCRIPTION OF THE DRAWINGS

The drawings illustrate the features of the disclosure on the basis of various exemplary embodiments, and in particular:

FIG. 1 shows a schematic illustration of a section of a solenoid valve which has a housing and a solenoid armature,

FIG. 2 shows a solenoid armature with two cylinder sections and a junction region, wherein the solenoid armature has a second duct wall region which extends over both cylinder sections and the junction region, and

FIG. 3 shows a solenoid armature with two cylinder sections and a junction region, wherein the solenoid armature has a second duct wall region which extends over a cylinder section and, in certain areas, over the junction region.

### DETAILED DESCRIPTION

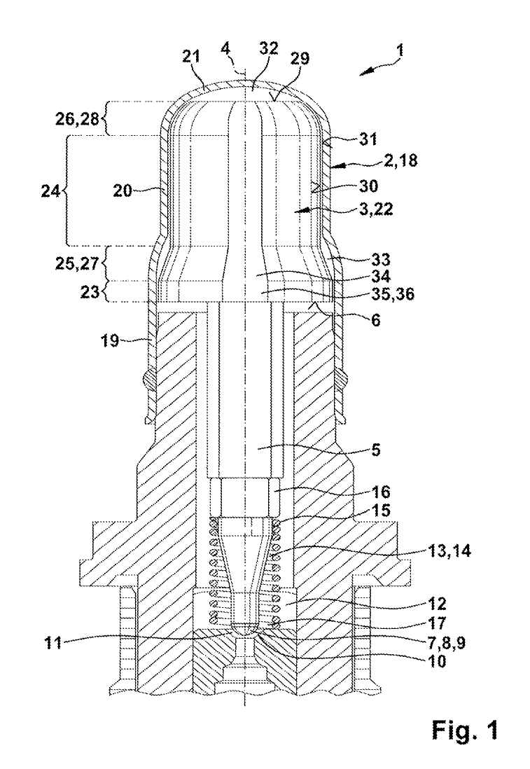

FIG. 1 shows a schematic illustration of a longitudinal section through a section of a solenoid valve 1. The solenoid valve 1 has a housing 2 and a piston-like solenoid armature 3. The solenoid armature 3 is arranged in the housing 2 in such a way that it can move axially along the longitudinal axis 4 thereof. The solenoid valve 1 also has a plunger 5, which starts from the planar base surface 6 of the solenoid armature 3 and accordingly follows an axial movement of the solenoid armature 3. The free end 7 of the plunger 5 is shaped as a sealing geometry 8 which is embodied as a spherical cap 9. The sealing geometry 8 interacts with a funnel-shaped valve seat 10, wherein the two components form a closable passage 11 in a valve space 12 for a pressure medium. The exemplary embodiment in FIG. 1 shows the solenoid valve 1 in an opened state, that is to say the sealing geometry 8 is located in a position in which it is lifted off from the valve seat 10, and the medium can flow through the passage 11. A restoring element 13, which is embodied as a helical compression spring 14, engages with its one end 15 on a shoulder 16 of the plunger 5 and with its other end 17 on the valve seat 10, with the result that owing to the spring force of the solenoid armature 3 is pressed upward via the plunger 5 in FIG. 1, and the sealing geometry 8 is therefore located in the position in which it is lifted off from the valve seat 10. A solenoid, which can be plugged axially onto the housing 2 and in the plugged-on state surrounds the housing 2 in the region of the solenoid armature 3, is not illustrated in FIG. 1. Energizing the solenoid causes an electromagnetic force to be applied to the solenoid armature 3, which solenoid armature 3 consequently carries out an axial movement, with the plunger 5, along the longitudinal axis 4 of said solenoid armature 3 and counter to the spring force. The sealing geometry 8 is therefore pressed into the valve seat 10 when the solenoid is energized, and the passage 11 for the pressure medium is closed. The strength of the current can be used to set the degree of opening or of closing of the solenoid valve 1, and therefore the quantity of the medium flowing through and the solenoid valve 1 can be used as an actuating valve.

The housing 2 is embodied as a stepped housing 18 which has two axial sections 19, 20 which are embodied as circular hollow cylinders. The axial sections 19, 20 have different diameters, wherein the diameter of the axial section 20 is smaller than the diameter of the axial section 19. The axial sections 19, 20 each have a central axis, which central axes are aligned with the longitudinal axis 4 of the solenoid armature 3. At the junction between the axial sections 19, 20, the diameter of the housing 2 changes continuously. The end of the axial section 20 which points away from the cylinder section 19 is adjoined by a dome-like region 21 of the housing 2.

The solenoid armature 3 is embodied as a stepped solenoid armature 22. The stepped solenoid armature 22 has two cylinder sections 23, 24, a junction region 25 and a head region 26. The junction region 25 is embodied essentially as a circular truncated cone 27 and connects the cylinder section 23, having a larger diameter, to the cylinder section 24 having a smaller diameter, wherein the cylinder sections 23, 24 are located offset with respect to one another in the axial direction in relation to the longitudinal axis 5. The head region 26 adjoins the cylinder section 24 axially. Said head region 26 is in the form of a flattened dome 28, with the result that the solenoid armature 3 has a planar end surface 29.

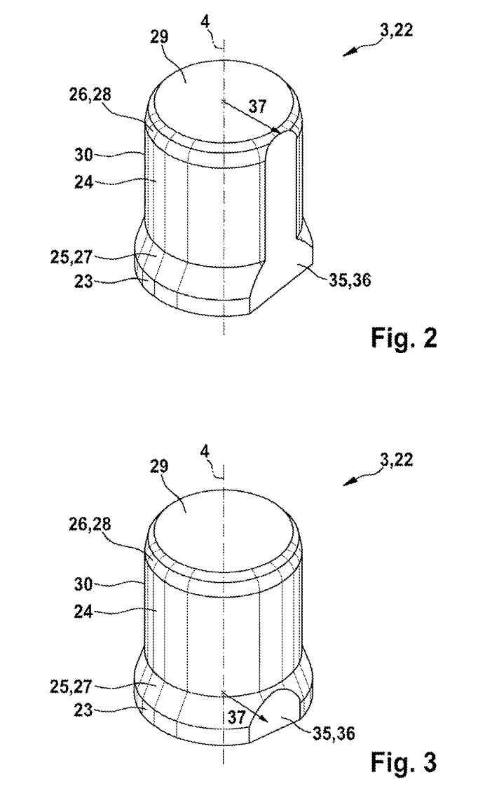

The solenoid armature 3 has an axial flow duct 34 which runs parallel to the longitudinal axis 4. This flow duct 34 is bounded, on the one hand, by a section of the cylinder inner wall 31, which forms a first duct wall region, and, on the other hand, by a section 35, shaped as a plane, of the solenoid armature wall 30 which forms a second duct wall region 36 (not visible in the illustrated longitudinal section). The flow duct 34 penetrates the cylinder sections 23, 24, the junction region 25 and the head region 26. In FIG. 2, the solenoid armature 3 is illustrated in a three-dimensional view, wherein the section 35 of the solenoid armature casing wall 30 which extends as a plane can be seen in FIG. 1.

A cavity 32, whose volume is variable owing to the movement of the solenoid armature, is formed between the dome-like region 21 of the housing 2 and the end surface 29, shaped in a planar fashion, of the solenoid armature 2. Furthermore, an annular cavity 33 with a variable volume is formed between the solenoid armature casing wall 30 and the cylinder inner wall 31 of the axial section 19.

The following function occurs: if the solenoid which surrounds the solenoid armature 3 is sufficiently energized, the solenoid armature 30 moves downward with the plunger 5 according to FIG. 1 and the sealing geometry 8 is pressed into the valve seat 10, thereby closing the passage 11 of the solenoid valve 1. In this context, the volume of the valve space 12 is reduced and the volumes of the cavity 32 and of the annular cavity 32 are enlarged. Owing to the pressure gradient, the medium flows from the valve space 12 through the flow duct 34 into the cavity 32 and into the annular cavity 33. The movement of the solenoid armature is damped by the flow movement of the medium, and therefore a possible oscillation of the solenoid armature 3, which can lead to the generation of undesired noise effects in the vehicle, are prevented by the flow movement of the medium. The same also applies to the opening of the solenoid valve 1. In this context, the volumes of the cavity 32 and of the annular cavity 33 are reduced and the pressure gradient points in the opposite direction to that when the solenoid valve 1 closes. The medium flows through the flow duct 34 in the direction of the valve space 12 and damps the movement of the solenoid armature.

FIG. 3 illustrates a further exemplary embodiment of a solenoid armature 3. The solenoid armature 3 in FIG. 3 corresponds to the solenoid armature 3 illustrated in FIGS. 1 and 2, with the result that in this respect reference is made to the statements relating to FIGS. 1 and 2. A difference is that the solenoid armature 3 has a section 35, embodied in a planar fashion, of the solenoid armature casing wall 30 which extends along the cylinder section 23 and in certain areas along the junction region 25. This section 35 forms the second duct wall region 36 of the flow duct 34.

If the solenoid valve 1 is moved into the closed position, the medium can flow from the valve space 12 through the flow duct 34 and into the annular cavity 33. If the solenoid valve 1 is opened, the medium flows from the annular cavity 33 through the flow duct 34 and into the valve space 12. In this context, the movement of the solenoid armature is hydraulically damped.

In FIG. 3, the minimum radial distance 37 of the section 35 of the solenoid armature casing wall 30 from the longitudinal axis 4 is larger than in the exemplary embodiment in FIG. 2. In FIG. 3, the minimum radial distance 37 is smaller than half the diameter of the cylinder section 23 and larger than half the diameter of the cylinder section 24. Consequently, the flow duct 34 extends only along the cylinder section 23 and in certain areas along the junction region 25. Only the annular cavity 33 is therefore connected to the valve space 12 in terms of flow. In contrast, in FIG. 2 the minimum radial distance 37 is smaller than half the diameter of the two cylinder sections 23, 24 and accordingly the flow duct 34 extends along the two cylinder sections 23, 24, the junction region 25 and the head region 26. Accordingly, both the annular cavity 33 and the cavity 32 are connected to the valve space 12 in terms of flow.

According to the disclosure it is possible to manufacture the solenoid armature 3 for the solenoid valve 1 in a simple and cost-effective way. Through the section 35 of the solenoid armature casing wall 30 of the solenoid armature 3 which is embodied in a planar fashion it is possible to implement large damping effects of the movement of the solenoid armature 3 in the housing 2 by wetting the solenoid armature 3 by means of a pressure medium. This damping is brought about hydraulically by the formation of shearing layers, with the result that undesired noise effects in the vehicle owing to the use of the solenoid valve 1 are avoided.

What is claimed is:

1. A solenoid valve, comprising:
a housing which extends in an axial direction and has at least one axial section which is configured as a circular hollow cylinder,
a solenoid armature which is removably guided in the housing along a cylinder inner wall in the axial direction along the longitudinal axis of said housing, the solenoid armature having a solenoid armature casing wall,
wherein at least one axial flow duct for a medium is located in the housing and is configured to permit a flow around the solenoid armature,
wherein the flow duct has a first and a second duct wall region, and the first duct wall region is formed by a section of the cylinder inner wall and the second duct wall region is formed by a section of the solenoid armature casing wall, and
wherein the second duct wall region is configured as a planar second duct wall region.

2. The solenoid valve according to claim 1, wherein the solenoid armature has at least a cylinder shape which, when viewed in cross section, has a straight contour region originating from the second duct wall region and a contour region in the form of a pitch circle.

3. The solenoid valve according to claim 1, wherein the second duct wall region runs parallel to the longitudinal axis of the solenoid armature.

4. The solenoid valve according to claim 1, wherein the housing is configured as a stepped housing, with at least two axial sections which have diameters of different sizes and are configured as circular hollow cylinders.

5. The solenoid valve according to claim 1, wherein the solenoid armature is configured as a stepped solenoid armature, with at least two cylinder sections which are located with an axial offset with respect to the longitudinal axis thereof, and wherein at least one of the cylinder sections has the flow duct.

6. The solenoid valve according to claim 1, wherein a junction region is arranged between the two cylinder sections.

7. The solenoid valve according to claim 1, wherein the junction region is configured as a truncated cone.

8. The solenoid valve according to claim 1, wherein the flow duct penetrates the junction region.

9. The solenoid valve according to claim 1, wherein a plurality of flow ducts are arranged distributed in the circumferential direction.

10. The solenoid valve according to claim 7, wherein the truncated cone is a circular truncated cone.
